(19) United States
(12) Patent Application Publication
(10) Pub. No.: US 2015/0372758 A1
(43) Pub. Date: Dec. 24, 2015

(54) TRANSMITTING AND RECEIVING APPARATUS USING WAVELENGTH-TUNABLE FILTER AND METHOD THEREOF

(71) Applicant: ELECTRONICS AND TELECOMMUNICATIONS RESEARCH INSTITUTE, Daejeon-si (KR)

(72) Inventors: Sil Gu MUN, Daejeon-si (KR); Eun Gu LEE, Daejeon-si (KR); Jyung Chan LEE, Daejeon-si (KR); Sang Soo LEE, Daejeon-si (KR)

(21) Appl. No.: 14/741,634

(22) Filed: Jun. 17, 2015

(30) Foreign Application Priority Data
Jun. 20, 2014 (KR) 10-2014-0076057

(51) Int. Cl. H04B 10/40

(52) U.S. Cl. CPC H04B 10/40

(57) ABSTRACT

A transmitting and receiving apparatus using a wavelength-tunable filter according to an exemplary embodiment may include: a filter to generate a filtered optical-reception signal by passing only an allowed-to-be-passed wavelength by using Bragg grating filter; a wavelength setter to set the allowed-to-be-passed wavelength of the filter; and a photoelectric converter to perform photoelectric conversion on the filtered optical-reception signal into an electrical signal.

### CROSS-REFERENCE TO RELATED APPLICATION(S)

This application claims the benefit under 35 U.S.C. §119(a) of Korean Patent Application No. 10-2014-0076057, filed on Jun. 20, 2014, in the Korean Intellectual Property Office, the entire disclosure of which is incorporated herein by reference for all purposes.

### BACKGROUND

1. Field

The following description relates to a technology regarding passive optical communications networks, and more specifically to a wavelength-tunable transmitting and receiving apparatus using a wavelength-tunable filter over passive optical communications networks.

2. Description of the Related Art

Due to the dramatic growth of multimedia content forms, including images, data, and audio, along with increased use of various applications after the invention of the smartphone, traffic demands are quickly rising, which in turn, requires subscribers to attain higher bandwidths that can ensure sufficient accommodation of wired network traffic. In order to solve problems in existing networks caused by the limitation of transmission capacity and the decline of transmission, various forms of wavelength-division multiplexed passive optical networks for subscribers have been proposed. Since the Telecommunication Standardization Sector of the International Telecommunication Union's (ITU-T) standardization of Gigabit-capable Passive Optical Networks (G-PON) and 10-Gigabit-capable PON (XG-PON) technologies in 2010, efforts to standardize next generation PON (NG-PON2) technology has been in progress by the Full Service Access Network (FSAN) Group.

NG-PON2 uses one-to-n (1: n) optical splitters at existing local nodes, so the existing optical distribution network (ODN) for time-division multiplexed PON (TDM-PON) may be used without any changes. Furthermore, NG-PON2 uses the wavelength-tunable optical network unit (ONU) for all subscribers so as to allow flexible change of the wavelength of the optical signal that is being used, meaning that each ONU should be in charge of selecting the wavelength that corresponds to the channels that the existing remote nodes (RN) support and that the wavelength-tunable technology for selecting a wavelength should be embedded in an optical receiver of the ONU.

For the existing wavelength-tunable receiver, one for which speed is low and a narrow bandwidth is used for monitoring the optical power of channels in metro networks or in reconfigurable optical add-drop multiplexer (ROADM) networks, was researched. In fact, in-depth research was conducted for a wavelength-tunable receiver that uses a narrow bandwidth, but it is difficult for such a wavelength-tunable receiver to be efficient when applied to the receiver of a transceiver that requires high-speed transmission. Prior art, U.S. Registration No. 7,002,697 presented implementations regarding wavelength tunability for overcoming the aforementioned difficulty by doping semiconductors via metalorganic chemical vapor deposition (MOCVD) growth. However, because of the inherent characteristics that the structure of the related art (U.S. Registration. No. 7,002,697) has, said art uses a narrow wavelength bandwidth and has bad channel isolation characteristics that degrade transmission characteristics.

### SUMMARY

The purpose of the present disclosure is to provide a transmitting and receiving apparatus, which has good channel isolation characteristics and can be simply implemented due to a simple design of the wavelength bandwidth, and which also does not make the degradation in performance when receiving high-speed signals.

In one general aspect, a transmitting and receiving apparatus using a wavelength-tunable filter includes: a filter to generate a filtered optical-reception signal by passing only an allowed-to-be-passed wavelength by using Bragg grating filter; a wavelength setter to set the allowed-to-be-passed wavelength of the filter; and a photoelectric converter to perform photoelectric conversion on the filtered optical-reception signal into an electrical signal. In addition, the transmitting and receiving apparatus may further include: an optical circulator to refract the optical-reception signal, transmit the refracted optical-reception signal to the filter, and transmit the filtered optical-reception signal, which has been received from the filter, to the photoelectric converter; and a transmitter to control a wavelength of a wavelength-tunable laser that is comprised therein so as to generate and transmit an optical-transmission signal having a preset wavelength.

The photoelectric converter may include a photodiode or an avalanche photodiode. The filter may pass only one allowed-to-be-passed wavelength among signals that have two or more wavelengths, each of which is different and comprised in the optical-reception signal. The allowed-to-be-passed wavelength may be designed according to policies of providers providing optical communications services.

In another general aspect, in a transmitting and receiving method using a wavelength-tunable filter, an allowed-to-be-passed wavelength of a Bragg grating filter may be set. If the allowed-to-be-passed wavelength is set, a filtered optical-reception signal may be generated by passing only an allowed-to-be-passed wavelength of a received optical-reception signal by using Bragg grating filter. Photoelectric conversion on the filtered optical-reception signal from an optical-signal into an electrical signal may be performed, and the electrical signal may be received. The transmitting and receiving method may further include controlling a wavelength of a wavelength-tunable laser that is comprised therein so as to generate and transmit an optical-transmission signal having a preset wavelength.

The performing of the photoelectric conversion on the filtered optical-reception signal into an electrical signal may include using a photodiode or an avalanche photodiode. The generating of the filtered optical-reception signal may include passing only one allowed-to-be-passed wavelength among signals with two or more wavelengths, each of which is different and comprised in the received optical-reception signal. The allowed-to-be-passed wavelength may be designed according to policies of providers providing optical communications services.

Other features and aspects may be apparent from the following detailed description, the drawings, and the claims.

### BRIEF DESCRIPTION OF THE DRAWINGS

FIG. 1 is a diagram illustrating an example of a link system using a wavelength-tunable filter.

FIG. 2 is a diagram illustrating an example of a transmitting and receiving apparatus using a wavelength-tunable filter.

FIG. 3 is a diagram illustrating another example of a wavelength-tunable receiver in a transmitting and receiving apparatus FIG. 2 using a wavelength-tunable filter.

FIG. 4 is a diagram illustrating an example of a link system using a wavelength-tunable receiver of FIG. 3.

FIG. 5 is a flowchart illustrating an example of a transmitting and receiving method using a wavelength-tunable filter.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

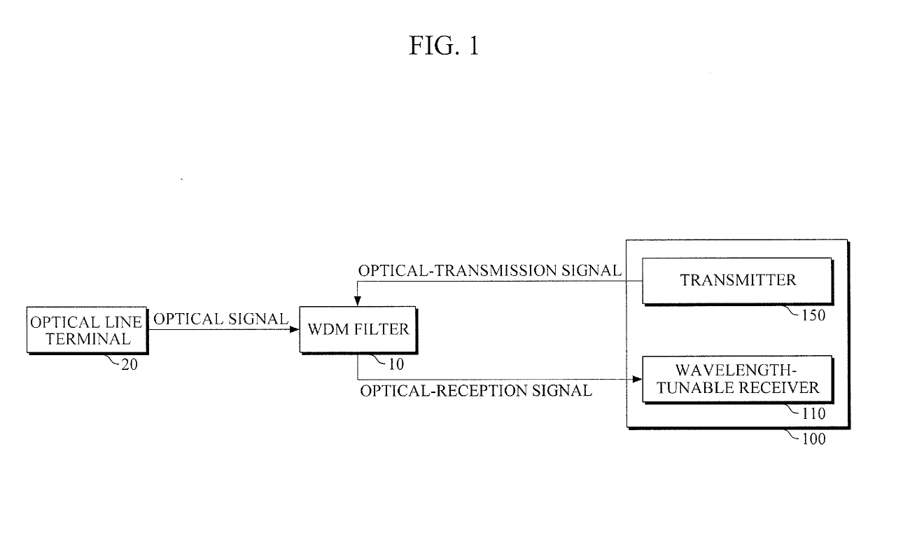

FIG. 1 is a diagram illustrating an example of a link system using a wavelength-tunable filter.

Referring to FIG. 1, a link system using a wavelength-tunable filter includes: a transmitting-receiving apparatus 100 that uses a wavelength-tunable filter; a wavelength-division multiplexing (WDM) filter 10; and an optical line terminal 20. The transmitting and receiving apparatus 100 using the wavelength-tunable filter includes a wavelength-tunable receiver 110 and a transmitter 150.

An optical signal, transmitted through an optical fiber cable from the optical line terminal 20 that is located in a central base station, is separated by a wavelength division multiplexing (WDM) filter 10 into an optical-transmission signal and an optical-reception signal, which are transmitted to the transmitting and receiving apparatus 100 that uses the wavelength-tunable filter. The WDM filter 10 separates the wavelength band of the transmitter 150 and the wavelength band of the wavelength-tunable receiver 110, and designs each wavelength band to be appropriate for providers' policies. The optical signal separated by the WDM filter 10 is incident on a Bragg grating filter through an optical circulator of the wavelength-tunable receiver 110, and adjusts a wavelength setter to pass only the wavelength part that is set (allowed) to be passed. The optical-reception signal filtered by the Bragg grating filter is transmitted to a photoelectric converter with a wide bandwidth, and photoelectric conversion is performed on the filtered optical-reception signal.

The transmitter 150 modulates a wavelength-tunable laser using a laser modulation driver in a laser modulator and transmits the modulated wavelength-tunable laser to the optical line terminal 20 through the WDM filter 10.

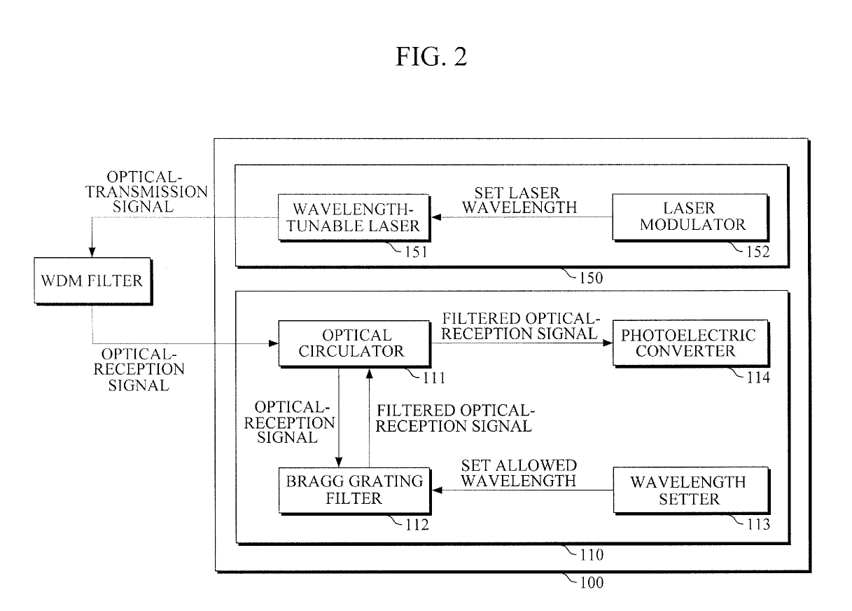

FIG. 2 is a diagram illustrating an example of a transmitting and receiving apparatus using a wavelength-tunable filter.

Referring to FIG. 2, a transmitting and receiving apparatus 100 using a wavelength-tunable filter in accordance with an exemplary embodiment includes a wavelength-tunable receiver 110 and a transmitter 150. The wavelength-tunable receiver 110 includes an optical circulator 111, a filter 112, a wavelength setter 113, and a photoelectric converter 114.

The WDM filter 10 separates a transmitted optical signal into an optical-transmission signal and an optical-reception signal. The WDM filter 10 transmits the separated optical-reception signal to the wavelength-tunable receiver 110. The WDM filter 10 separates the wavelength band of the transmitter 150 and the wavelength band of the wavelength-tunable receiver 110, and may design each wavelength band to be appropriate for providers' policies. The optical-reception signal separated by the WDM filter 10 is transmitted to the filter 112 by the optical circulator III.

The filter 112 is a Bragg grating filter, wherein the Bragg grating is used for selectively reflecting or removing the light of a specific wavelength according to a change cycle of the refractive index. The Bragg grating filter may be easily made of a filter used in an external resonant laser, and also easily produced due to a simple design of the wavelength-tunable range and the wavelength-tunable bandwidth. Also, the Bragg grating filter does not make system degradation due to good channel isolation characteristics when a high-speed signal is transmitted. The filter 112 passes a wavelength part, which is allowed to be passed, among various wavelengths included in the optical-reception signal received by using characteristics of such Bragg grating. The wavelength, which the filter 112 passes, is controlled by the wavelength setter 113. The wavelength setter 113 sets an allowed-to-be-passed wavelength that the filter 112 passes so as to control the filter 112 to pass only the relevant wavelength part from the received optical-reception signal. The optical-reception signal filtered by the filter 112 is transmitted to the photoelectric converter 114.

The photoelectric converter 114 receives the optical-reception signal filtered by the filter 112. The photoelectric converter 114 performs photoelectric conversion on the received optical-reception signal to receive it as an electrical signal. The photoelectric converter 114 may be substituted to a photoelectric element, such as a photodiode or an avalanche photodiode, etc.

The transmitter 150 includes a wavelength-tunable laser 151 and a laser modulator 152. The laser modulator 152 controls the wavelength of the wavelength-tunable laser 151 so that the wavelength-tunable laser 151 generates an optical-transmission signal having the allowed wavelength. The wavelength-tunable laser 151 generates the optical-transmission signal that has the wavelength, which is set according to the control of the laser modulator 152, and transmits the generated optical-transmission signal to the WDM filter 10.

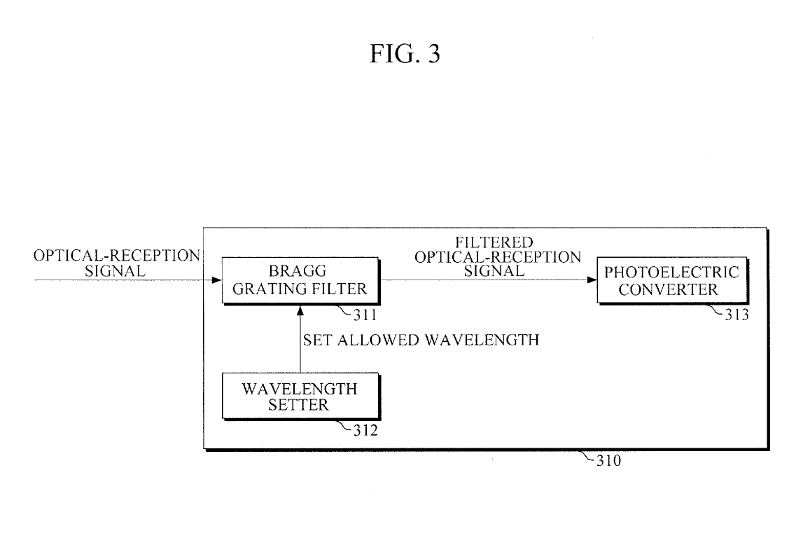

FIG. 3 is a diagram illustrating another example of a wavelength-tunable receiver in a transmitting and receiving apparatus of FIG. 2 using a wavelength-tunable filter.

Referring to FIG. 3, another example of a wavelength-tunable receiver 310 in a transmitting and receiving apparatus of FIG. 2 includes a Bragg grating filter 311, a wavelength setter 312, and a photoelectric converter 313.

The Bragg grating filter 311 is a filter, wherein the Bragg grating is used for selectively reflecting or removing the light of a specific wavelength according to a change cycle of the refractive index. The Bragg grating filter 311 passes the wavelength part, which is allowed to be passed, among several wavelengths included in the optical-reception signal received by using characteristics of such Bragg grating. The wavelength, which the Bragg grating filter 311 passes, is controlled by the wavelength setter 312. The wavelength setter 312 sets a wavelength that the Bragg grating filter 311 passes so as to control the Bragg grating filter 311 to pass only the relevant wavelength part from the received optical-reception signal. The optical-reception signal filtered by the Bragg grating filter 311 is transmitted to the photoelectric converter 313.

The photoelectric converter 313 receives the optical-reception signal filtered by the Bragg grating filter 311. The photoelectric converter 313 performs photoelectric conversion on the received optical-reception signal to receive it as an electrical signal. The photoelectric converter 313 may be substituted to a photoelectric element, such as a photodiode or an avalanche photodiode, etc.

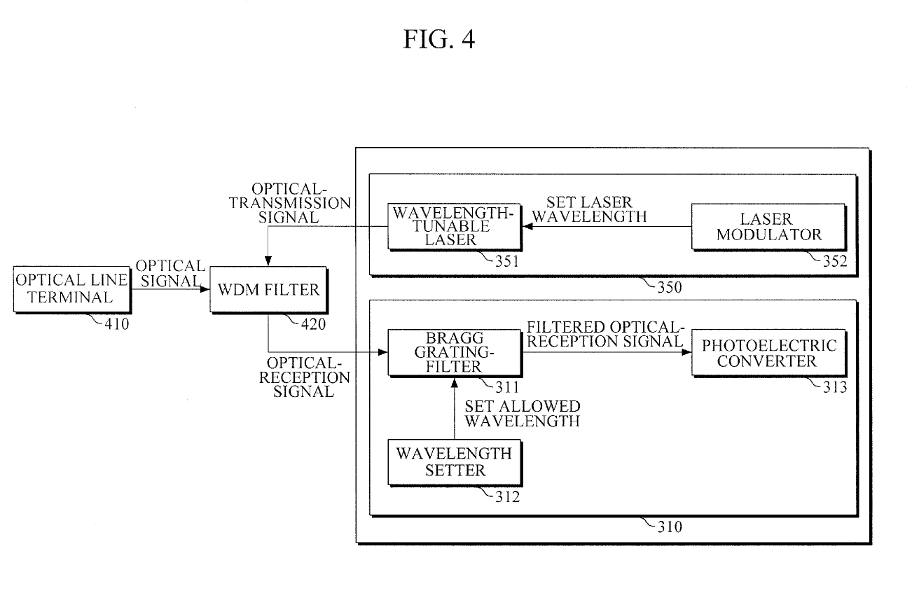

FIG. 4 is a diagram illustrating an example of a link system using a wavelength-tunable receiver of FIG. 3.

Referring to FIG. 4, a link system using a wavelength-tunable receiver 310 includes an optical line terminal 410, a WDM filter 420, and a transmitting and receiving apparatus 300 using a wavelength-tunable filter. The transmitting and receiving apparatus 300 includes a wavelength-tunable receiver 310 and a transmitter 350.

An optical signal, transmitted through an optical fiber cable from the optical line terminal (OLT) 410 that is located in a central base station, is separated by a wavelength division multiplexing (WDM) filter 420 into an optical-transmission signal and an optical-reception signal, which are transmitted to the transmitting and receiving apparatus 300 that uses the wavelength-tunable filter. The WDM filter 10 separates the wavelength band of the transmitter 350 and the wavelength band of the wavelength-tunable receiver 310, and designs each wavelength band to be appropriate for providers' policies. The optical signal separated by the WDM filter 420 is incident on a Bragg grating filter, and adjusts a wavelength setter to pass only the wavelength part that is allowed to be passed. The optical-reception signal filtered by the Bragg grating filter is transmitted to a photoelectric converter with a wide bandwidth, and photoelectric conversion is performed on the filtered optical-reception signal.

The wavelength-tunable receiver 310 includes a Bragg grating filter 311, a wavelength setter 312, and a photoelectric converter 313. The Bragg grating filter 311 is a filter, wherein the Bragg grating is used for selectively reflecting or removing the light of a specific wavelength according to a change cycle of the refractive index. The Bragg grating filter 311 passes the wavelength part, which is allowed to be passed, among several wavelengths included in the optical-reception signal received by using characteristics of such Bragg grating. The wavelength, which the Bragg grating filter 311 passes, is controlled by the wavelength setter 312. The wavelength setter 312 sets a wavelength that the Bragg grating filter 311 passes so as to control the Bragg grating filter 311 to pass only the relevant wavelength part from the received optical-reception signal. The optical-reception signal filtered by the Bragg grating filter 311 is transmitted to the photoelectric converter 313.

The photoelectric converter 313 receives the optical-reception signal filtered by the Bragg grating filter 311. The photoelectric converter 313 performs photoelectric conversion on the received optical-reception signal to receive it as an electrical signal. The photoelectric converter 313 may be substituted to a photoelectric element, such as a photodiode or an avalanche photodiode, etc.

The transmitter 350 includes a wavelength-tunable laser 351 and a laser modulator 352. The laser modulator 352 controls the wavelength of the wavelength-tunable laser 351 so that the wavelength-tunable laser 351 generates an optical-transmission signal having the allowed wavelength. The wavelength-tunable laser 351 generates the optical-transmission signal that has the wavelength, which is set according to the control of the laser modulator 352 and transmits the generated optical-transmission signal to the WDM filter 420.

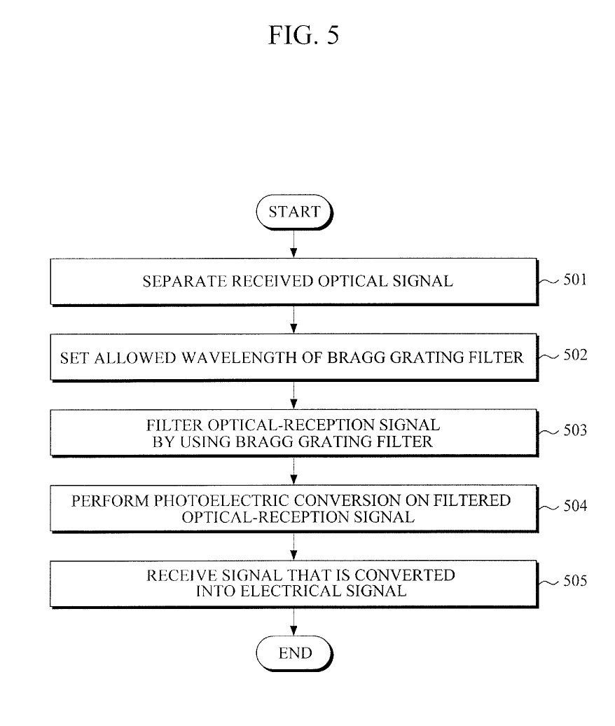

FIG. 5 is a flowchart illustrating an example of a transmitting and receiving method using a wavelength-tunable filter.

Referring to FIG. 5, a transmitting and receiving method using a wavelength-tunable filter includes an operation 501 of separating a transmitted optical signal through a WDM filter. If an optical signal is transmitted through an optical fiber cable from an optical line terminal that is located in a central base station, the transmitted optical signal is separated into an optical-transmission signal and an optical-reception signal by using a WDM filter. The WDM filter separates the wavelength band of the transmitter and the wavelength band of the wavelength-tunable receiver, and designs each wavelength band to be appropriate for providers' policies.

Then, an allowed-to-be-passed wavelength of the filter is set in 502 so as to pass only the required wavelength. The received optical-reception signal is an optical signal with the divided wavelength, which includes not only one but several wavelengths. Thus, the allowed-to-be-passed wavelength of the filter is set to be filtered so as to pass only the required wavelength among the several wavelengths included in the received optical-reception signal.

If the allowed-to-be-passed wavelength is set, the received optical-reception signal is filtered using the filter in 503. A signal with the required (allowed) wavelength is filtered among many signals, which has each different wavelength and are included in the optical-reception signal that has been received according to the allowed-to-be-passed wavelength of the filter so that the filtered optical-reception signal is received.

If the optical-reception signal is filtered by the filter and the filtered optical-reception signal is received, the photoelectric conversion is performed on the filtered optical-reception signal in 504. The optical-reception signal filtered by the Bragg grating filter is transmitted to a photoelectric converter with a wide bandwidth, and photoelectric conversion is performed on the filtered optical-reception signal. The photoelectric conversion is performed on the filtered optical-reception signal by using a photoelectric element, such as a photodiode or an avalanche photodiode, etc. When the photoelectric conversion is performed on the filtered optical-reception signal, the filtered optical-reception signal is converted to an electrical signal, and in 505, the electronic signal is transmitted to a terminal on each side of the users.

A transmitting and receiving apparatus and method using a wavelength-tunable filter according to an exemplary embodiment may make a simple design of the wavelength-tunable range and the wavelength-tunable bandwidth so as to be designed properly for systems and link specifications, to which such a design is to be applied. In addition, a WDM filter and a wavelength-tunable receiver are capable of being modulated and integrated into a single element which is easy for miniaturization. Due to good characteristics of the channel isolation of the wavelength-tunable filter, the degradation in performance is less likely to occur when a signal is transmitted. Also, the transmitting and receiving apparatus and method does not use high-priced optical elements so as to be implemented at a low price.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A transmitting and receiving apparatus using a wavelength-tunable filter, the transmitting and receiving apparatus comprising:
a filter configured to generate a filtered optical-reception signal by passing only an allowed-to-be-passed wavelength by using Bragg grating filter;
a wavelength setter configured to set the allowed-to-be-passed wavelength of the filter; and
a photoelectric converter configured to perform photoelectric conversion on the filtered optical-reception signal into an electrical signal.

2. The transmitting and receiving apparatus of claim 1, further comprising:
an optical circulator configured to refract the optical-reception signal, transmit the refracted optical-reception signal to the filter, and transmit the filtered optical-reception signal, which has been received from the filter, to the photoelectric converter.

3. The transmitting and receiving apparatus of claim 1, further comprising:
a transmitter configured to control a wavelength of a wavelength-tunable laser that is comprised therein so as to generate and transmit an optical-transmission signal having a preset wavelength.

4. The transmitting and receiving apparatus of claim 1, wherein the photoelectric converter comprises a photodiode or an avalanche photodiode.

5. The transmitting and receiving apparatus of claim 1, wherein the filter is configured to pass only one allowed-to-be-passed wavelength among signals that have two or more wavelengths, each of which is different and comprised in the optical-reception signal.

6. The transmitting and receiving apparatus of claim 5, wherein the allowed-to-be-passed wavelength is designed according to policies of providers providing optical communications services.

7. A transmitting and receiving method using a wavelength-tunable filter, the transmitting and receiving method comprising:
setting an allowed-to-be-passed wavelength of a Bragg grating filter;
generating a filtered optical-reception signal by passing only an allowed-to-be-passed wavelength of a received optical-reception signal by using Bragg grating filter;
performing photoelectric conversion on the filtered optical-reception signal into an electrical signal.

8. The transmitting and receiving method of claim 7, further comprising:
controlling a wavelength of a wavelength-tunable laser that is comprised therein so as to generate an optical-transmission signal having a preset wavelength.

9. The transmitting and receiving method of claim 7, wherein the performing of the photoelectric conversion on the filtered optical-reception signal into an electrical signal comprises using a photodiode or an avalanche photodiode.

10. The transmitting and receiving method of claim 7, wherein the generating of the filtered optical-reception signal comprises passing only one allowed-to-be-passed wavelength among signals with two or more wavelengths, each of which is different and comprised in the received optical-reception signal.

11. The transmitting and receiving method of claim 10, wherein the allowed-to-be-passed wavelength is designed according to policies of providers providing optical communications services.
